(19) United States
(12) Patent Application Publication
(10) Pub. No.: US 2007/0169901 A1
(43) Pub. Date: Jul. 26, 2007

(54) Process for impregnating woodchips

(76) Inventor: Jakob Friederich Werz, Ruvigliana (CH)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/646,189

(22) Filed: Dec. 27, 2006

(30) Foreign Application Priority Data
Dec. 27, 2005 (EP) 05 405 724.5

(51) Int. Cl. D21C 9/10; D21B 1/36; B27N 3/00

(52) U.S. Cl. 162/71; 162/22; 264/109

(57) ABSTRACT

In a process for impregnating woodchips with substances dissolved and/or emulsified in water as impregnating agents for improving the elastic, mechanical, chemical and/or biological properties by vacuum impregnation and drying with dry steam, the woodchips are mixed with the substances dissolved and/or emulsified in water. The mixture is then evacuated to a pressure of 0.05 to 0.075 MPa and, after a contact time of 30 to 300 seconds, is treated with dry steam at 2 to 4 bar gauge pressure. Woodchips impregnated by the process are suitable in particular as a filler for wood/plastic composite materials.

The invention relates to a process for impregnating woodchips with substances dissolved and/or emulsified in water as impregnating agents for improving the elastic, mechanical, chemical and/or biological properties by vacuum impregnation and drying with dry steam.

Woodchips are used as a filler for a large number of wood/plastic composite materials. Both thermosetting plastics and thermoplastics may be used as the plastic matrix. The wood particles comprising sawdust, planing chips or so-called cutting chips are brought to the desired size and shape by subsequent milling. The thickness of the wood particles is usually in the range of 0.2-0.5 mm and the ratio of width to length. (slimness) is between 1:3 and 1:10.

After drying and fractionation, the chip material is present in the desired shape and size.

For the production of the wood/plastic mixture, the wood particles are homogeneously mixed with the plastic matrix in suitable mixers, such as, for example, in high-speed rotary mixers, kneading machines, heating-cooling mixers or mixing extruders.

The mixture thus produced can be pressed or injected into moulds for the production of the actual composite material. Extrusion to give rods, profiles and similar semi-finished products is also possible.

By changing the proportion of wood or of plastic in the wood/plastic composite, the performance characteristics, mechanical or elastic properties and the surface quality can be changed and influenced in a targeted manner. By adding further additives, such as, for example, colored pigments or lubricants, or by the combination of different plastics, an attractive surface, good handle properties and the like and optical and haptic properties can be achieved.

Furthermore, it is possible to achieve an improvement in the quality and the performance characteristics of the composite material by suitable choice of the timbers used and by influencing the wood properties in a targeted manner.

DE-A-195 21 623 discloses, in a process for impregnating wood with sucrose solution, first treating the wood parts in a container with dry steam and then impregnating them by an autogenously produced vacuum effect.

In a process disclosed in EP-B-1 216 801 for impregnating wood, a dispersion is prepared from an impregnating agent which contains impregnating oil and water-soluble polymers as thickeners. The dispersion is heated to a temperature between 100 and 130° C. and introduced into an impregnating vessel with the wood to be impregnated. The impregnating agent is introduced into the wood by means of one or more pressure cycles.

EP-A-1 004 413 describes a process for the production of impregnated woodchips for use as insulating material. The chips are dried at a temperature of 150° C. to the combustion limit of the chip material and then sprayed with an impregnating agent. A pressure of up to 20 bar may act on the chips.

It is the object of the invention to provide a process of the type mentioned at the outset, by means of which the disadvantageous properties of the wood filler, such as, for example, swellability, water absorptivity, susceptibility to rotting due to wood-destroying organisms or combustibility, can be reduced.

The object is achieved, according to the invention, if the woodchips are mixed with the substances dissolved and/or emulsified in water and the mixture is then evacuated to a pressure of <0.1 MPa and, after a contact time of at least 20 seconds, is treated with dry steam at 1.5 to 6 bar gauge pressure.

Evacuation is preferably effected to a pressure of 0.05 to 0.075 MPa.

The contact time is preferably 30 to 300 seconds.

The dry steam preferably has a gauge pressure of 2 to 4 bar, in particular about 3 bar.

Preferred impregnating agents are emulsions of natural and/or synthetic waxes or resins or solutions of minerals or salts, such as, for example, solutions containing boric acid or borax (sodium borate).

The impregnating agents may also contain prepolymers which are completely polymerized only in a further process step.

The process according to the invention is particularly suitable for impregnating woodchips having a preferred thickness of 0.2 to 0.5 mm and a preferred ratio of width to length of 1:3 to 1:10.

A particularly preferred application of woodchips impregnated by the process according to the invention is their use as a filler for wood/plastic composite materials.

The invention is explained in more detail below with reference to two examples.

### EXAMPLE 1

Woodchips in the form of so-called fine particles having an average length of less than 0.5 mm were introduced together with an aqueous paraffin emulsion into an autoclave. The woodchips and the paraffin emulsion were mixed by thorough stirring. The container was then evacuated to a pressure of 0.07 MPa. After a contact time of 200 seconds, the container was fed with dry steam at 3 bar. The chip material was dried with stirring and the paraffin was fixed on the chips. The water absorptivity of the woodchips could be reduced by 60%.

### EXAMPLE 2

Frame saw chips were introduced together with an aqueous boric acid solution into the autoclave and treated in the same manner as in example 1. The chips thus treated were, on a substrate, inoculated with spores of wood-destroying fungi and stored under warm and moist conditions. This treatment protected the woodchips from fungal attack.

With the process according to the invention, it is possible to achieve numerous advantages over the conventional production of woodchips.

Particularly with the use of thermoplastics, any presence of moisture in the woodchips and/or the additives is troublesome. Addition of additives as a solution together with a glue—as is usual in the case of water-soluble thermosetting plastic resins—is accordingly not possible. Admixing as a powder or in another solid form is as a rule not possible or possible only to a limited extent owing to the different specific densities of the components. Moreover, there is then once again the possibility of separation when further processing. Impregnation of the wood prior to chipping would be very complicated and the loading of the wood substance with the additive or additives would not be sufficiently uniform; impregnation at ambient pressure by means of substances dissolved in water and subsequent drying by contact heat and/or convection is conceivable in principle but technologically and technically complicated and expensive.

In developing the invention, it is envisaged that the impregnation of the woodchips be carried out by the process according to the invention and, depending on the quality requirement, further substances be admixed for improving various properties of the woodchips. According to the invention, it is furthermore envisaged that, for improving the properties of the woodchips, binders and/or emulsions of natural and/or synthetic waxes or resins and/or solutions of minerals or salts and/or prepolymers and/or fungicides be mixed with the woodchips.

1. Process for impregnating woodchips with substances dissolved and/or emulsified in water as impregnating agents for improving the elastic, mechanical, chemical and/or biological properties by vacuum impregnation and drying with dry steam, characterized in that
the woodchips are mixed with the substances dissolved and/or emulsified in water and the mixture is then evacuated to a pressure of <0.1 MPa and, after a contact time of at least 20 seconds, is treated with dry steam at 1.5 to 6 bar gauge pressure.

2. Process according to claim 1, characterized in that evacuation is effected to a pressure of 0.05 to 0.075 MPa.

3. Process according to claim 1 or 2, characterized in that the contact time is 30 to 300 seconds.

4. Process according to any of claims 1 to 3, characterized in that the dry steam has 2 to 4 bar gauge pressure, in particular about 3 bar gauge pressure.

5. Process according to any of claims 1 to 4, characterized in that the woodchips have a thickness of 0.2 to 0.5 mm and a ratio of width to length of 1:3 to 1:10.

6. Process according to any of claims 1 to 5, characterized in that the impregnating agents are emulsions of natural and/or synthetic waxes or resins.

7. Process according to any of claims 1 to 6, characterized in that the impregnating agents are solutions of minerals or salts.

8. Process according to claim 7, characterized in that the impregnating agents contain boric acid or borax.

9. Process according to any of claims 1 to 6, characterized in that the impregnating agents contain prepolymers.

10. Use of woodchips impregnated by the process according to any of claims 1 to 9 as a filler for wood/plastic composite materials.
